(19) United States
(12) Patent Application Publication
(10) Pub. No.: US 2008/0260063 A1
(43) Pub. Date: Oct. 23, 2008

(54) Sequence generating method

(75) Inventors: Ching Wei Chen, Hsinchu (TW); Yan Xiu Zheng, Hsinchu (TW); Yu Ted Su, Hsinchu (TW); Chi Fang Li, Hsinchu (TW)

Correspondence Address: BACON & THOMAS, PLLC, 625 SLATERS LANE, FOURTH FLOOR, ALEXANDRIA, VA, 22314-1176, US

(73) Assignees: Industrial Technology Research Institute, HsinChu (TW); National Chiao Tung University, Hsinchu City (TW)

(21) Appl. No.: 11/984,911

(22) Filed: Nov. 26, 2007

(30) Foreign Application Priority Data
Apr. 20, 2007 (TW) 96114031

(51) Int. Cl. H04L 23/02; H04L 27/28

(52) U.S. Cl. 375/267; 375/260

(57) ABSTRACT

This invention provides a sequence generating method, in which the method has steps of generating R sets of orthogonal sequence with each set of the orthogonal sequence including N elements, generating a low-autocorrelation sequence having N elements, and multiplying the N elements of the low-autocorrelation sequence by the N elements of each of R sets of the orthogonal sequence point-to-point. Therefore, a sequence generated by the method of the present invention has low-autocorrelation and low-crosscorrelation in transmission characteristics of a communication system.

### FIELD OF THE INVENTION

The present invention relates to a sequence generating method, and more particularly to a sequence generating method that has both the characteristics of low-autocorrelation and low-crosscorrelation.

### BACKGROUND OF THE INVENTION

Cellular communication systems are network infrastructures that are broadly utilized in most common mobile communication networks comprised of multiple base stations. Each base station is further capable of dividing the coverage area in the network into sub-areas by using directional antennas to improve frequency spectrum utilization efficiency and system capacity. Cellular communication systems, however, inherit distortion due to interference from multi-path configurations, and require channel estimation of the transmitting signal for post-signal processing.

Low-autocorrelation sequences, e.g. FZC sequences or GCL (Generalized Chirp-Like) sequences are commonly used in channel estimation techniques. In the case of the GCL sequence, because it has the characteristic of low-autocorrelation, it is usually used as the Pilot or Preamble sequence. FIG. 4A and FIG. 4B show relationship diagrams of the crosscorrelation and autocorrelation of the GCL sequence.

According to FIG. 4A, an autocorrelation value is obtained by multiplying a sequence with its shifted auto-sequence. There are a total of 67 elements in the GCL sequence in FIG. 4A, and when the GCL sequence is multiplied by its self-shifted sequence, the autocorrelation value between the GCL sequence and its self-shifted-by-1 sequence will be 0. The result of the multiplied autocorrelation value will be 0 up to multiplied by self-shifted-by-66, and multiplying the GCL sequence by its self-shifted-by-67 sequence can be viewed as multiplied by itself as an un-shifted sequence, and obtaining a maximum autocorrelation value of 67. Therefore, it has been proven that the GCL sequence has a very low-autocorrelation.

According to FIG. 4B, a crosscorrelation value is obtained by multiplying a sequence by another sequence. In 67 sets of GCL sequence, multiplying the first set of the GCL sequence by the second set of the GCL sequence will result in a non-zero crosscorrelation value, up to multiplied by 67^{th} set of GCL sequence, all the crosscorrelation values are non-zero. While multiplying the first GCL sequence by itself will result in a maximum crosscorrelation value of 67. Therefore, it has been proven that the GCL sequence cannot achieve low-crosscorrelation.

Currently known low-autocorrelation sequences, e.g. FZC sequences or GCL sequences, cannot achieve the characteristic of low-crosscorrelation. Therefore, when using FZC sequences or GCL sequences as Cell IDs, false determination will occur during such identification processes.

### SUMMARY OF THE INVENTION

The present invention relates to a sequence generating method that is applicable to a Pilot sequence, a Preamble sequence, or a channel estimation in a communication system. The sequence generated by the present invention has both characteristics of low-autocorrelation and low-crosscorrelation.

In order to generate a sequence with both the characteristics of low-autocorrelation and low-crosscorrelation, the present invention provides a sequence generating method including generating R sets of orthogonal sequence with each set of the orthogonal sequence having N elements, generating a low-autocorrelation sequence having N elements, and multiplying the N elements of the low-autocorrelation sequence by the N elements of each of the R sets of the orthogonal sequence point-to-point to generate R sets of output sequence, in which the R sets of the orthogonal sequence are generated from Hadamard matrix, Walsh matrix, or OVSF matrix, the low-autocorrelation sequence is generated from a FZC sequence or a GCL sequence, and the output sequence can be transferred to a time-domain signal by applying upon an inverse Fourier transformation.

The present invention also provides a Pilot sequence generating method, including selecting R sets of orthogonal sequence generated from Hadamard matrix, Walsh matrix, or OVSF matrix, selecting a low-autocorrelation sequence generated from a FZC sequence or a GCL sequence, and multiplying the low-autocorrelation sequence by elements of each of the R sets of orthogonal sequence point-to-point to generate R sets of output sequence as the Pilot sequence for a communication system.

The present invention also provides a Preamble sequence generating method, including selecting R sets of orthogonal sequence generated from Hadamard matrix, Walsh matrix, or OVSF matrix, selecting a low-autocorrelation sequence generated from a FZC sequence or a GCL sequence, and multiplying the low-autocorrelation sequence by elements of each of the R sets of orthogonal sequence point-to-point to generate R sets of output sequence as the Preamble sequence for a communication system.

The sequence generated by the present invention has both characteristics of low-autocorrelation and low-crosscorrelation, and is applicable to a Pilot sequence, a Preamble sequence, or for channel estimation in a communication system.

### BRIEF DESCRIPTION OF THE DRAWINGS

The objective, spirits and advantages of the present invention will be readily understood by following detailed description with accompanying, wherein:

FIG. 1 is a diagram of an application system in accordance with one embodiment of the present invention;

FIG. 2 is a flow chart of a sequence generating method in accordance with one embodiment of the present invention;

FIG. 3A is a relationship diagram for the autocorrelation of an output sequence of the present invention;

FIG. 3B is a relationship diagram for the crosscorrelation of the output sequence of the present invention;

FIG. 4A is a relationship diagram for the autocorrelation of conventional GCL sequence; and

FIG. 4B is a relationship diagram for the crosscorrelation of conventional GCL sequence.

### DETAILED DESCRIPTION OF THE EMBODIMENTS

The present invention relates to a sequence generating method, particularly to a method for generating a sequence having both characteristics of low-autocorrelation and low-crosscorrelation. In an embodiment of the present invention, the sequence generated by the method of the present invention is applicable to a communication system.

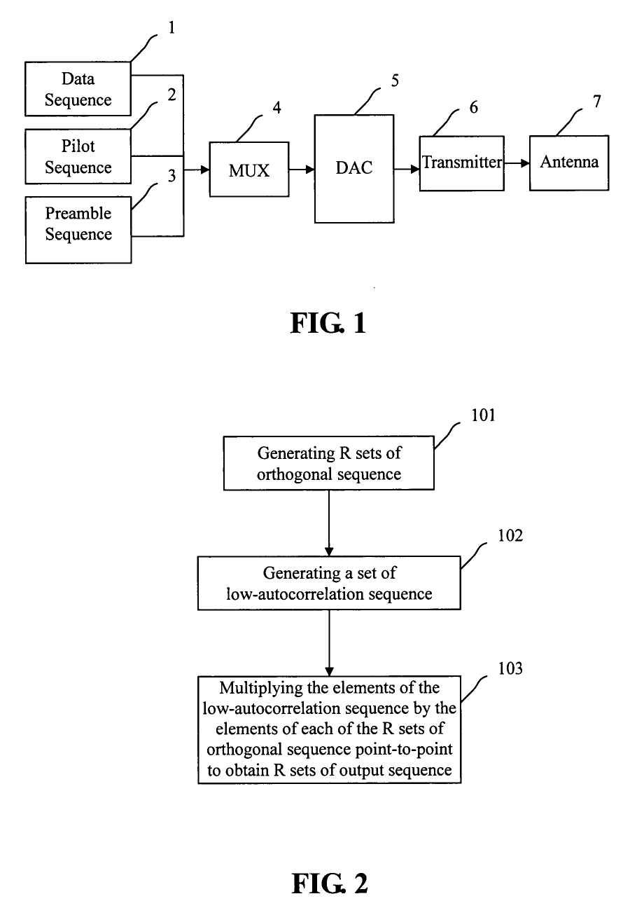

FIG. 1 shows a diagram of an application system in accordance with one embodiment of the present invention. As shown in FIG. 1, in order to identify users or their Cell IDs, or estimate channel parameters in a communication system, a Data Sequence 1 has to pass through a multiplexer (MUX) 4 to integrate it with a Pilot Sequence 2 or a Preamble Sequence 3, and form a standardized Frame Format data stream. The data stream will then be transmitted from a transmitter 6 after passing through a digital-to-analog converter (DAC) 5.

The Pilot Sequence 2 or Preamble Sequence 3 shares an antenna 7 of the transmitter 6 for performing phase estimation, compensation, frame synchronization, frequency synchronization, channel estimation, or identity recognition.

As being applied to perform the phase estimation and compensation, the Pilot Sequence 2 or Preamble Sequence 3 must have the characteristic of low-autocorrelation, and as being used to distinguish users or Cell IDs, the Pilot Sequence 2 or Preamble Sequence 3 must also have the characteristic of low-crosscorrelation.

The sequence generating method of the present invention is capable of generating a sequence that has both characteristics of low-autocorrelation and low-crosscorrelation. As such, the method of the present invention is applicable to generate the Pilot Sequence 2 or the Preamble Sequence 3.

FIG. 2 shows the flow chart of the sequence generating method in accordance with one embodiment of the present invention. Referring to FIG. 2, at Step 101, generating R sets of orthogonal sequence, and each set of the R sets of the orthogonal sequence includes N elements. At step 102, a low-autocorrelation sequence is generated, and that includes N elements. Then, at step 103, the low-autocorrelation sequence is multiplied by the elements of each of the R sets of the orthogonal sequence point-to-point to obtain R sets of output sequence. The element numbers and the sets of the output sequences can be customized according to the system application environment.

In the embodiment of the present invention, at step 101, the R sets of the orthogonal sequence can be generated from Hadamard matrix, Walsh matrix, or OVSF matrix. In one embodiment of the present invention, the R sets of the orthogonal sequence are generated from Hadamard matrix, wherein the Hadamard matrix is derived from a 2×2 base matrix H₂, and the H₂ matrix is indicated as below:

$${H}_{2} = [ \begin{matrix}1 & 1 \\ 1 & - 1\end{matrix} ]$$

When the sets of the orthogonal sequence to be required exceed 2, the base matrix H₂ can be recursively expanded to form a 2ⁿ×2ⁿ matrix H₂_{ⁿ}, wherein R=2ⁿ as indicated below:

$${H}_{{2}^{n}} = [ \begin{matrix}{H}_{{2}^{n - 1}} & {H}_{{2}^{n - 1}} \\ {H}_{{2}^{n - 1}} & - {H}_{{2}^{n - 1}}\end{matrix} ]$$

Extracting each row from the matrix H₂_{ⁿ} obtains a set of the orthogonal sequence. Therefore, each of the R sets of the orthogonal sequences from step 101 contains R elements.

In one embodiment of the present invention, the R sets of orthogonal sequence can be generated from Walsh matrix, wherein the Walsh recursive formula is indicated as below:

$${W}_{1} = ( 0 )$$

$${W}_{2 n} = [ \begin{matrix}{W}_{n} & {W}_{n} \\ {W}_{n} & {\overline{W}}_{n}\end{matrix} ]$$

In the above formula, n is the matrix dimension and W̅ₙ̅ is the Boolean NOT operation of the bits of Wₙ, while each row of the Walsh matrix is orthogonal to other rows and its Boolean inverse.

When R=2n, each row extracted from the generated matrix W₂ₙ, is a set of orthogonal sequence. Each of the R sets of the orthogonal sequence from step 101 contains R elements.

In the embodiment of the present invention, the low-autocorrelation sequence from step 102 can be generated from either a FZC sequence or a GCL sequence. In one embodiment of the present invention, the low-autocorrelation sequence is generated from the GCL sequence, wherein the formula for GCL sequence is indicated as below:

$${a}_{k} = exp ( j \frac{M π {k}^{2}}{{2}^{m}} )$$

According to the above formula, when parameter K is set to R, the GCL sequence results in a GCL sequence F_{R} of R elements as indicated below:

F_{R}=(a₀,a₁,a₂, . . . ,a_{R-1})

Further, according to the formula for GCL sequence, the parameters M and m are set to result in the sequence value of the low-autocorrelation sequence F_{R} in step 102.

In the embodiment of the present invention, the R sets of output sequence are obtained by multiplying the low-autocorrelation sequence by the elements of each of the R sets of the orthogonal sequence point-to-point at step 103. According to the above embodiment, the Hadamard matrix H₂_{ⁿ} generated in step 101 and the GCL sequence F_{R} generated in step 102 are multiplied point-to-point in step 103, wherein each element in the GCL sequence F_{R} is multiplied by the corresponding element in each row from the R sets of the Hadamard matrix H₂_{ⁿ} to generate an R×R matrix H_{R×R}. A desired output sequence is selected from the rows in the H_{R×R} matrix.

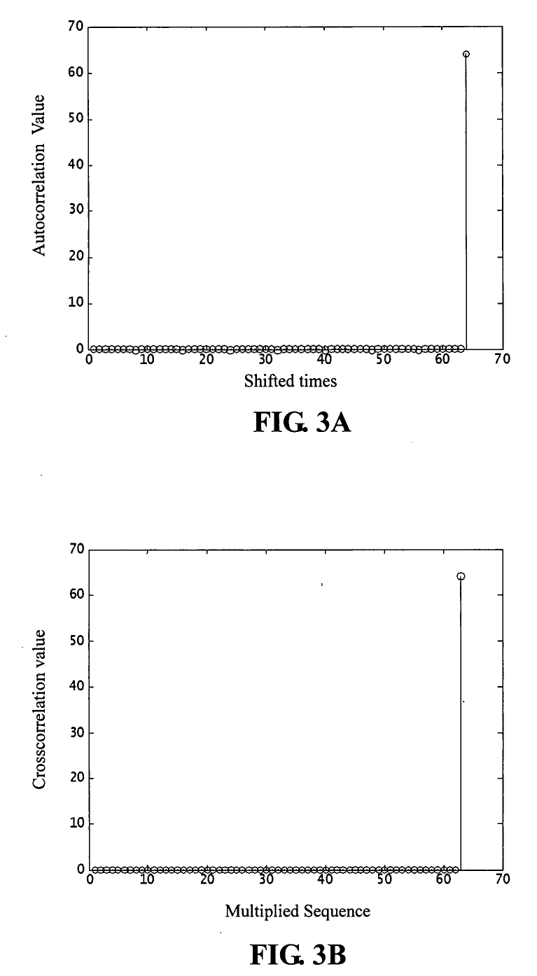

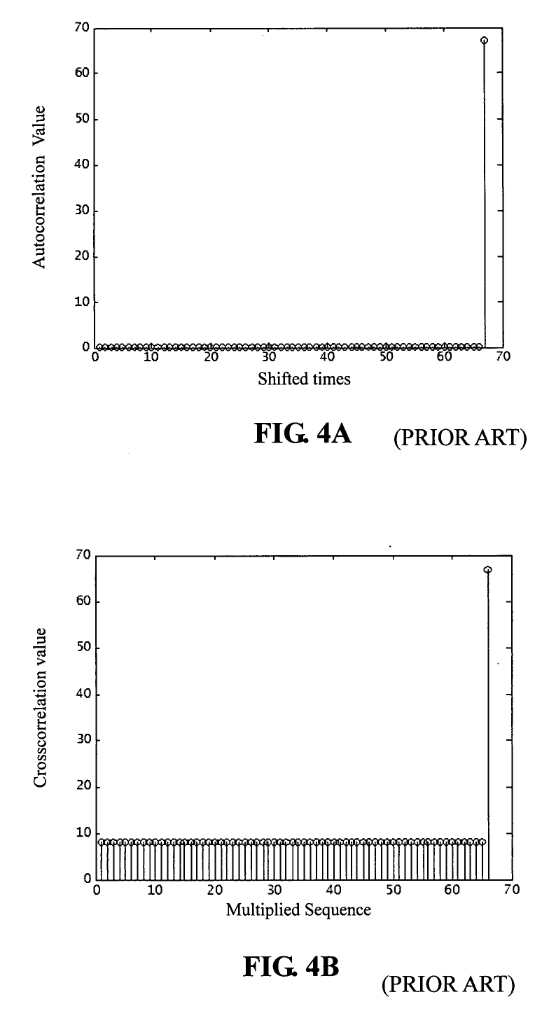

In an embodiment of the present invention, when the parameter M of the GCL sequence is set to 3, the low-autocorrelation sequence F_{R} and Hadamard matrix H₂_{ⁿ} are multiplied point-to-point by their elements to generate R sets of the output sequence. FIG. 3A and FIG. 3B show the relationship diagrams of the autocorrelation and crosscorrelation of the R sets of the output sequence.

As shown in FIG. 3A, when R equals 64, it means that there are 64 sets of the output sequence. Taking the first set of the output sequence as example, the first set of the output sequence is multiplied by its self-shifted sequence to generate the correlation value. When the first set of the output sequence is self-shifted-by-64, the self-shifted-by-64 sequence is the same with the original first set of the output sequence, and considering as the first set of the output sequence is un-shifted. It can be found from the diagram that when the first set of the output sequence is multiplied by its self-shifted-by-1 sequence up to multiplying its self-shifted-by-63 sequence, each of the multiplications results in a correlation value of 0. When the first set of the output sequence is multiplied by itself as the un-shifted sequence, the correlation value attains a maximum value of 64. Therefore, the output sequence of the present invention has an excellent characteristic of low-autocorrelation.

According to FIG. 3B, R equals 64, and the first set of the output sequence is multiplied by the second set of the output sequence, the third set of the output sequence, and so on, up to the 64^{th} set of output sequence, as well as the first set of the output sequence itself. It can be found from the diagram that when the first set of the output sequence is multiplied by the second set of the output sequence, third set of output sequence, and so on, up to the 64^{th} set of output sequence, the correlation values are all 0. When the first set of the output sequence is multiplied by itself, the correlation value has a maximum value of 64. Therefore, the output sequence of the present invention has an excellent characteristic of low-crosscorrelation.

In one embodiment of the present invention, when the desired output sequence requires R sets and R elements, where R is not a power of 2, then in step 101, the Hadamard matrix with a power of 2 is used to generate a 2ⁿ×2ⁿ matrix H₂_{ⁿ}. Thereafter, an R×R matrix H_{R×R} is selected from the matrix H₂_{ⁿ} as the R sets of the orthogonal sequence. And, in step 103, the GCL sequence F_{R} with R elements is multiplied point-to-point by the R rows in the selected matrix H_{R×R} from step 101, and to obtain R sets of output sequence with R elements, wherein, when the selected matrix from step 101 approaches the center of the matrix H₂_{ⁿ}, the generated output sequences will have lower characteristics of autocorrelation and crosscorrelation.

In one embodiment of the present invention, when the desired output sequence does not require the number of sets is the same with that of elements, e.g. the desired output sequence requires R1 sets and R2 elements, in step 101, the Hadamard matrix with a power of 2 is used to generate a 2ⁿ×2ⁿ matrix H₂_{ⁿ}, and an R1×R2 matrix H_{R1×R2} is selected from the matrix H₂_{ⁿ}. In step 103, the GCL sequence F_{R2} with R2 elements is multiplied point-to-point by R1 rows in the matrix H_{R1×R2}, and to obtain R1 sets of output sequence with R2 elements, wherein, when the selected matrix from step 101 approaches the center of the matrix H₂_{ⁿ}, the generated output sequences will have lower characteristics of autocorrelation and crosscorrelation.

In one embodiment of the present invention, when the desired output sequence requires R1 sets and R elements, wherein R=2ⁿ, the GCL sequence F_{R} with the R elements from step 103 can be directly multiplied point-to-point by the 2ⁿ×2ⁿ matrix H₂_{ⁿ} to obtain an R×R output matrix H_{R×R}, and the R1×R output sequence is then selected from the output matrix H_{R×R}. When the selected output sequence approaches the center of the matrix H_{R×R}, the generated output sequences will have lower characteristics of autocorrelation and crosscorrelation.

In one embodiment of the present invention, when the generated output sequence is applied to an OFDM system, based on the system requirements for sequence characteristics, the generated output sequence in step 103 can be inserted into either the time domain signal or frequency domain signal. When the system requires the sequence positively having the characteristics of low-autocorrelation and low-crosscorrelation in the frequency domain, the output sequence will be inserted into the frame of the frequency domain, and then IFFT is applied to transform the output sequence into a time domain. When the system requires the output sequence positively having the characteristics of low-autocorrelation and low-crosscorrelation in the time domain, the output sequence will be inserted into the frame of the time domain. This type of sequence is typically used as the Pilot or Preamble sequences in an OFDM.

In one embodiment of the present invention, when the generated output sequence is required to fulfill extraneous frequency-energy distribution, elements from both front and back ends of each output sequence from step 103 can be discarded in order to satisfy the extraneous frequency-energy distribution.

The sequence generating method of the present invention can generate a sequence having both the characteristics of low-autocorrelation and low-crosscorrelation. Therefore, the sequence generating method of the present invention can be applied to Pilot sequences, Preamble sequences, or for channel estimation.

With a detailed description of the various embodiments of this invention, those skilled in the art will readily appreciate that various modifications and changes can be applied to the embodiments of the invention as hereinbefore described without departing from its scope, defined in and by the appended claims. In addition, the embodiments should be construed as a limitation on the actual applicable description of the invention.

What is claimed is:

1. A sequence generating method, comprising:
generating R sets of orthogonal sequence, each set of the orthogonal sequence includes N elements;
generating a low-autocorrelation sequence having N elements; and
multiplying the N elements of said low-autocorrelation sequence by the N elements of each of said R sets of the orthogonal sequence point-to-point to generate R sets of output sequence.

2. The sequence generating method as claimed in claim 1, wherein said R sets of the orthogonal sequence are generated from Hadamard matrix, Walsh matrix, or OVSF matrix.

3. The sequence generating method as claimed in claim 1, wherein said low-autocorrelation sequence is generated from an FZC sequence or a GCL sequence.

4. The sequence generating method as claimed in claim 1, wherein said output sequence is applied with a transformation method to transform a signal of a specific domain into another defined domain.

5. The sequence generating method as claimed in claim 4, wherein said transformation method is an inverse Fourier transformation to transform a signal of a frequency domain into a signal of a time domain.

6. The sequence generating method as claimed in claim 4, wherein said transformation method is a Fourier transformation to transform a signal of a time domain into a signal of a frequency domain.

7. A sequence generating method, comprising:
generating R sets of orthogonal sequence, each set of the orthogonal sequence includes N1 elements;
selecting N2 elements from each of said R sets of the orthogonal sequence respectively;
generating a low-autocorrelation sequence having N2 elements; and
multiplying the N2 elements of said low-autocorrelation sequence by the selected N2 elements of each of the R sets of the orthogonal sequence point-to-point to generate R sets of output sequence.

8. The sequence generating method as claimed in claim 7, wherein said R sets of the orthogonal sequence are generated from Hadamard matrix, Walsh matrix, or OVSF matrix.

9. The sequence generating method as claimed in claim 7, wherein said low-autocorrelation sequence is generated from an FZC sequence or a GCL sequence.

10. The sequence generating method as claimed in claim 7, wherein said output sequence is applied with a transformation method to transform a signal of a specific domain into another defined domain.

11. The sequence generating method as claimed in claim 10, wherein said transformation method is an inverse Fourier transformation to transform a signal of a frequency domain into a signal of a time domain.

12. The sequence generating method as claimed in claim 10, wherein said transformation method is a Fourier transformation to transform a signal of a time domain into a signal of a frequency domain.

13. A Pilot sequence generating method, comprising:
selecting R sets of orthogonal sequence generated from Hadamard matrix, Walsh matrix, or OVSF matrix;
selecting a low-autocorrelation sequence generated from a FZC sequence or a GCL sequence; and
multiplying elements of said low-autocorrelation sequence by elements of each of said R sets of the orthogonal sequence point-to-point to generate R sets of output sequence as the Pilot sequence for a communication system.

14. The sequence generating method as claimed in claim 13, wherein said output sequence is applied with a transformation method to transform a signal of a specific domain into another defined domain.

15. The sequence generating method as claimed in claim 14, wherein said transformation method is an inverse Fourier transformation to transform a signal of a frequency domain into a signal of a time domain.

16. The sequence generating method as claimed in claim 14, wherein said transformation method is a Fourier transformation to transform a signal of a time domain into a signal of a frequency domain.

17. A Preamble sequence generating method, comprising:
selecting R sets of orthogonal sequence generated from Hadamard matrix, Walsh matrix, or OVSF matrix;
selecting a low-autocorrelation sequence generated from a FZC sequence or a GCL sequence; and
multiplying elements of said low-autocorrelation sequence by elements of each of said R sets of the orthogonal sequence point-to-point to generate R sets of output sequence as the Preamble sequence for a communication system.

18. The sequence generating method as claimed in claim 17, wherein said output sequence is applied with a transformation method to transform a signal of a specific domain into another defined domain.

19. The sequence generating method as claimed in claim 18, wherein said transformation method is an inverse Fourier transformation to transform a signal of a frequency domain into a signal of a time domain.

20. The sequence generating method as claimed in claim 18, wherein said transformation method is a Fourier transformation to transform a signal of a time domain into a signal of a frequency domain.

21. A channel estimation sequence generating method, comprising:
selecting R sets of orthogonal sequence generated from Hadamard matrix, Walsh matrix, or OVSF matrix;
selection a low-autocorrelation sequence generated from an FZC sequence or a GCL sequence; and
multiplying elements of said low-autocorrelation sequence by elements of each of said R sets of the orthogonal sequence point-to-point to generate R sets of output sequence as the channel estimation sequence for a communication system.

22. The sequence generating method as claimed in claim 21, wherein said output sequence is applied with a transformation method to transform a signal of a specific domain into another defined domain.

23. The sequence generating method as claimed in claim 22, wherein said transformation method is an inverse Fourier transformation to transform a signal of a frequency domain into a signal of a time domain.

24. The sequence generating method as claimed in claim 22, wherein said transformation method is a Fourier transformation to transform a signal of a time domain into a signal of a frequency domain.
